(19) United States
(12) Patent Application Publication
(10) Pub. No.: US 2012/0131475 A1
(43) Pub. Date: May 24, 2012

(54) SOCIAL NETWORK BASED ON VIDEO RECORDER PARENTAL CONTROL SYSTEM

(75) Inventors: Kulvir S. Bhogal, Pflugerville, TX (US); Andrew R. Jones, Round Rock, TX (US); Brian M. O'Connell, RTP, NC (US); Mark W. Talbot, Austin, TX (US)

(73) Assignee: INTERNATIONAL BUSINESS MACHINES CORPORATION, Armonk, NY (US)

(21) Appl. No.: 12/950,351

(22) Filed: Nov. 19, 2010

(51) Int. Cl. H04N 5/445; G06F 3/01

(52) U.S. Cl. 715/753; 725/47

(57) ABSTRACT

A computer system, computer program product, and method of sharing and creating social network reviews of selected programs that may be viewed and shared over a social network. If a user agrees with a social network review already present for a selected program, the categorization and editing of inappropriate content of the selected program may be applied to the same program for that user. If a user disagrees with a social network review of a selected program already present, the user may review the selected program and edit any inappropriate content as desired and submit the review to the social network.

### BACKGROUND OF THE INVENTION

The present invention relates to video recorders, and more specifically to a social network based on digital video recorder parental control system.

A digital video recorder (DVR) or personal video recorder (PVR) is a device that records video in a digital format to a disk drive or other medium. The term “DVR” includes stand-alone set-top boxes and software for personal computers which enables video capture and playback to and from disk.

Parental controls are often included with a DVR and provide an ability for DVR users to block certain content from being viewed, either in real time or from a recording by requiring a personal identification number (PIN) or some other type of security approval.

Parental control systems for DVR's use a television content rating system incorporated into a V-chip or a simple lock that is manually added to the recorded content. Most DVR systems allow any user to select content to be recorded and apply a security lock upon a request to view the content. This system requires the person with the PIN to unlock the material to be viewed based upon either the recording name, the specified rating by the broadcaster, or by first viewing the content themselves.

Other alternatives for parents are to trust the discrete television rating system, review programming prior to enabling dependents to view the programming, researching each program that may be viewed, or discovering via other communicative means, (e.g. word of mouth, new casts, etc. . . . ) if a program is acceptable for their children.

### SUMMARY OF THE INVENTION

According to one embodiment of the present invention, a method for sharing reviews of programs for inappropriate content. The method includes a computer searching for a social network review and recommendation for a selected program from a computer-readable tangible storage device accessible to a social network program, the social network program being accessible to users of the social network and a computer-readable tangible storage device of the computer. If the social network review is not present, the computer creating the social network review by: the computer directed to display device to display the selected program to a user; the computer, in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device accessible to the social network program; and the computer, in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device accessible to the social network program, the social network program accessible to the computer.

According to another embodiment of the present invention, a computer system for sharing reviews of programs for inappropriate content with a social network. The computer system includes one or more processors, one or more computer-readable memories and one or more computer-readable, tangible storage devices of a social network program, the social network program being accessible to users of the social network and a computer-readable tangible storage device of a computer. Program instruction also included n the computer system. The program instructions are stored on at least one of the one or more storage devices for execution by at least one of the one or more processors via at least one of the one or more memories, to search for a social network review for a selected program from the computer-readable tangible storage device of a social network program. The program instructions are stored on at least one of the one or more storage devices for execution by at least one of the one or more processors via at least one of the one or more memories, to if the social network review is not present, the computer creating the social network review by: directing a display device to display the selected program to a user; in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device of a social network program; and in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device of a social network program, the social network program being accessible to the computer.

According to another embodiment of the present invention, a computer program product for reviews of programs for inappropriate content. The method includes one or more computer-readable, tangible storage devices of a social network program, the social network program being accessible to users of the social network and a computer-readable tangible storage device of a computer. The computer program product also includes program instructions, stored on at least one of the one or more storage devices, to search for a social network review for a selected program from the computer-readable tangible storage device of a social network program. The program instructions are stored on at least one of the one or more storage devices, to if the social network review is not present, the computer creating the social network review by: directing a display device to display the selected program to a user; in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device of a social network program; and in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device of a social network program, the social network program being accessible to the computer.

### BRIEF DESCRIPTION OF THE SEVERAL VIEWS OF THE DRAWINGS

FIG. 1 is a computer network in which illustrative embodiments may be implemented.

FIG. 2 is a data processing system in which illustrative embodiments may be implemented.

FIG. 3 shows a block diagram of a digital video recorder (DVR) in which illustrative embodiments may be implemented.

FIG. 4 shows a flowchart of a method of creating a user profile and matching the profile to other profiles in a social network according to an illustrative embodiment.

FIG. 5 shows a flowchart of a method of reviewing programs for content within a social network according to an illustrative embodiment.

FIG. 6A shows a flowchart of a method of reviewing the social network recommendations for program content review according to an illustrative embodiment.

FIG. 6B shows another flowchart of a method of reviewing the social network recommendations for program content review according to an illustrative embodiment.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In the course of developing the invention, the inventors found that for DVR parental control systems that contain a security lock, the person or user with the PIN may not have time to view all of the content to determine whether all or a portion or portions of the content should be blocked from viewing by others, and/or that the person or user with the PIN may have a standard for rating the content that differs from that of the broadcaster, thereby causing the broadcaster's rating to be ineffective. The inventors further found that other alternatives for parents for determining whether all or a portion or portions of the content should be blocked from viewing by others require a large amount of time and effort by the parents. Illustrative embodiments of the invention include a method, a system and a computer program product for reviewing broadcast for content for sharing reviews of programs which may have inappropriate content.

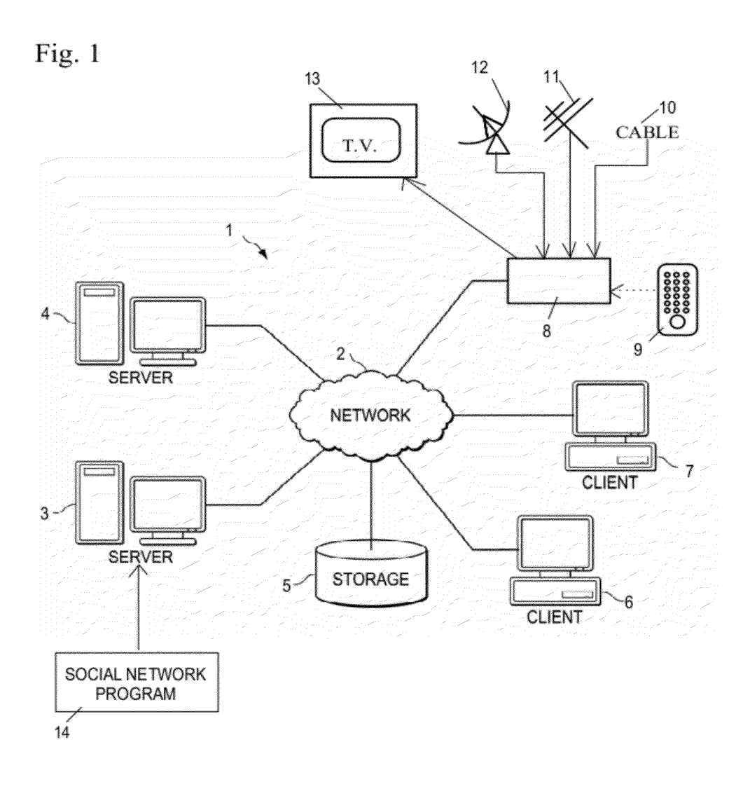

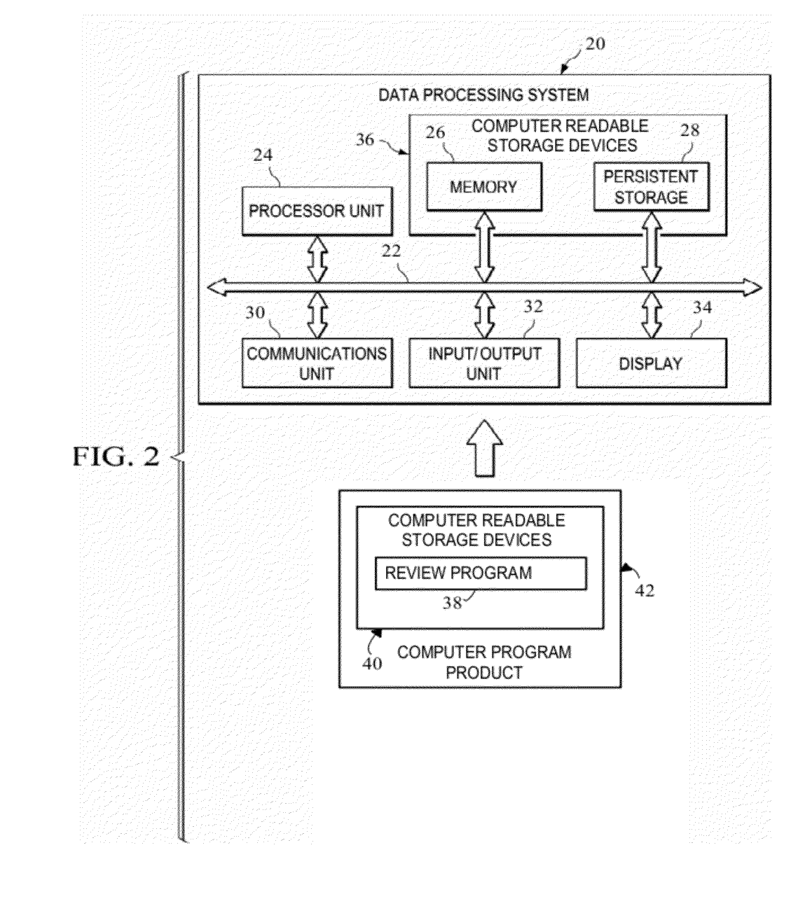

With reference now to the figures, and in particular, with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 1 is a network of computers in which illustrative embodiments may be implemented. Network data processing system 1 contains network 2, which is the medium used to provide communication links between various devices and computers connected together within network data processing system 1. Network 2 may include connections, such as wire, wireless communication links, or fiber optic cables.

In the depicted example, server 3 and server 4 connect to network 2 along with storage unit 5. In addition, clients 6 and 7 and digital video recorder (DVR) 8 connect to network 2. Server 3 can comprise a social network program 14 for managing a social network. A social network is a social structure made of nodes, which are generally individuals or organizations that are tied by one or more specific types of interdependency such as values or visions. Storage unit 5 is a computer-readable storage device. Clients 6 and 7 may be, for example, personal computers, network computers, or other portable devices. DVR 8 may be connected to cable 10, a television antenna 11, and/or satellite 12 to receive a signal from a broadcasting network that is displayed on a television (T.V.), monitor, or other display device 13 connected to the DVR 8. Universal remote 9 may be used to interact with the DVR 8. Clients 6 and 7 may also be used to interact with the DVR 8. In the depicted example, server 3 provides information, such as boot files, operating system images, and applications to clients 6 and 7, and DVR 8. Clients 6 and 7, and DVR 8 are clients to server 3 in this example. Network data processing system 1 may include additional servers, clients, and other devices not shown.

Program code or television broadcasts located in network data processing system 1 may be stored on a computer-readable storage device and downloaded to a data processing system or other device for use. For example, program code may be stored on storage unit 5 or a computer-readable storage device on server 4 and downloaded to DVR 8 over network 2 for use on DVR 8.

In the depicted example, network data processing system 1 is the Internet with network 2 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 1 also may be implemented as a number of different types of networks, such as, for example, an intranet, local area network (LAN), or a wide area network (WAN). FIG. 1 is intended as an example, and not as an architectural limitation, for the different illustrative embodiments.

With reference now to FIG. 2, a block diagram of a data processing system is shown in which illustrative embodiments may be implemented. Data processing system 20 is an example of a DVR, such as DVR 8 in FIG. 1, in which computer-readable program code or instructions may be located for the illustrative embodiments. Data processing system 20 can include communications fabric 22, processor unit 24, memory 26, persistent storage 28, communications unit 30, input/output (I/O) unit 32, and display 34. In this illustrative example, communications fabric 22 can provide communications between processor unit 24, memory 26, persistent storage 28, communications unit 30, input/output (I/O) unit 32, and display 34.

Processor unit 24 serves to execute instructions for software that may be loaded into memory 26. Processor unit 24 may be a set of one or more processors, or may be a multi-processor core, depending on the particular implementation. Further, processor unit 24 may be implemented using one or more heterogeneous processor systems in which a main processor is present with secondary processors on a single chip. As another illustrative example, processor unit 24 may be a symmetric multi-processor system containing multiple processors of the same type.

Memory 26 and persistent storage 28 are examples of computer-readable storage devices 36. Memory 26, in these examples, may be, for example, a random access memory or any other suitable volatile or non-volatile computer-readable storage device. Persistent storage 28 may take various forms depending on the particular implementation. For example, persistent storage 28 may contain one or more components or devices. For example, persistent storage 28 may be a hard drive, a flash memory, a rewritable optical disk, a rewritable magnetic tape, or some combination of the above. The media used by persistent storage 28 also may be removable. For example, a removable hard drive may be used for persistent storage 28.

Communications unit 30, in these examples, provides for communications with other data processing systems or devices. In these examples, communications unit 30 is a network interface card. Communications unit 30 may provide communications through the use of either or both physical and wireless communication links.

Input/output unit 32 allows for input and output of data with other devices that may be connected to data processing system 20. For example, input/output unit 32 may provide a connection for user input through a keyboard, a mouse, a universal remote, and/or some other suitable input device. Further, input/output unit 32 may send output to a printer. Display 34 provides a mechanism to display information to a user.

Instructions for an operating system, applications, and/or programs may be located in one or more of computer-readable storage devices 36. Computer-readable storage devices 36 are in communication with processor unit 24 through communications fabric 22. In these illustrative examples the instructions are in a functional form on persistent storage 28. These instructions may be loaded into memory 26 for running by processor unit 24. The processes of the different embodiments may be performed by processor unit 24 using program instructions, which may be located in a memory, such as memory 26.

These program instructions are also referred to as program code, computer usable program instructions, or computer-readable program instructions, that may be read and run by processor unit 24. The program code in the different embodiments may be embodied on different physical or tangible computer-readable storage devices, such as memory 26 or persistent storage 28.

Review program 38 is located in a functional form on computer-readable storage devices 40. One or more computer-readable storage devices 40 may be selectively removable. Review program 38 may be loaded onto or transferred to data processing system 20 for running by processor unit 24. Review program 38 and computer-readable storage devices 40 form computer program product 42 in these examples. In some instances, one or more of computer-readable storage devices 40 may not be removable.

Alternatively, review program 38 may be transferred to data processing system 20 from computer-readable storage devices 40 through a communications link to communications unit 30 and/or through a connection to input/output unit 32. The communications link and/or the connection may be physical or wireless in the illustrative examples.

In some illustrative embodiments, review program 38 may be downloaded over a network to persistent storage 28 from another device or data processing system for use within data processing system 20. For instance, program code stored in a computer-readable storage device in a server data processing system may be downloaded over a network from the server to data processing system 20. The data processing system providing review program 38 may be a server computer, a client computer, or some other device capable of storing and transmitting review program 38.

The different components illustrated for data processing system 20 are not meant to provide architectural limitations to the manner in which different embodiments may be implemented. The different illustrative embodiments may be implemented in a data processing system including components in addition to, or in place of, those illustrated for data processing system 20. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a bus system may be used to implement communications fabric 22 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 26 or a cache such as found in an interface and memory controller hub that may be present in communications fabric 22.

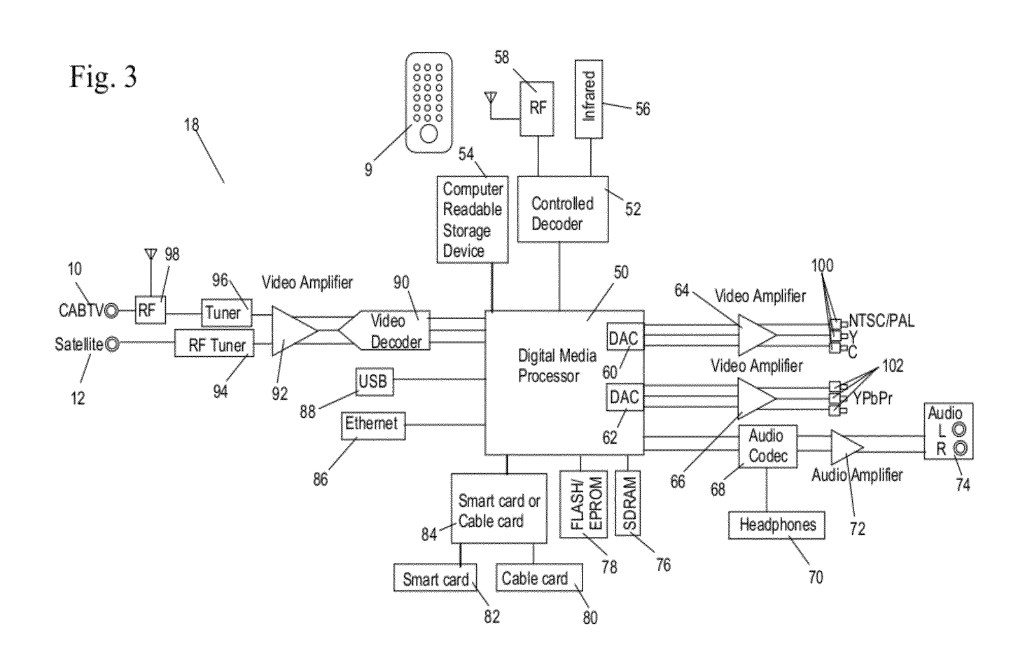

FIG. 3 shows an exemplary diagram of a video recorder, in particular a DVR 18, in which illustrative embodiments may be implemented. DVR 18 is another example of DVR 8 shown in FIG. 1. It should be appreciated that FIG. 3 is only exemplary and are not intended to assert or imply any limitation with regard to different embodiments which may be implemented. Modifications to DVR 18 may be made.

DVR 18 includes digital media processor 50 with at least one digital-to-analog converter 60 which is connected to a video amplifier 64 and has inputs 100 for National Television System Committee (NTSC)/phase alternate line (PAL), and composite video Y and C. A second digital-to-analog converter 62 is preferably present in the digital media processor 50 and is connected to a video amplifier 66 and has inputs 102 for YPbPr or component video.

Digital media processor 50 is also connected to audio codec 68 for encoding analog audio into digital signals and decoding digital signals into analog signals. Audio codec 68 is connected to headphones 70 and audio amplifier 72 for audio left L and right R outputs 74.

DVR 18 also has computer-readable storage device 54 as well as flash or erasable programmable read only memory (EPROM) 78 and synchronous dynamic random access memory (SDRAM) 76 enabling a user to store TV programs of their choosing.

Input 84 for smart card 82 or cable card 80 may be present with DVR 8 for users who need to decode an encrypted digital cable signal without using a set-top box.

DVR 18 has at least one tuner 96, and preferably has at least two tuners 94, 96. Tuner 96 is connected to receive an input for cable television 10 or to receive a broadcast signal through a radio frequency (RF) antenna 98. Tuner 96 is connected to video amplifier 92, which in turn is connected to video decoder 90 that sends a signal to digital media processor 50. Second tuner 94 is connected to input 12 for satellite and to video amplifier 92. From video amplifier 92, a signal goes through video decoder 90 to digital media processor 50. Digital media processor 50 also has a port to connect to Ethernet 86 or to another device through a universal serial bus (USB) port 88.

Universal remote 9 can control digital media processor 50 of DVR 18. Universal remote 9 communicates with controlled decoder 52, which is coupled to digital media processor 50 through infrared 56 or radio frequency (RF) signals 58.

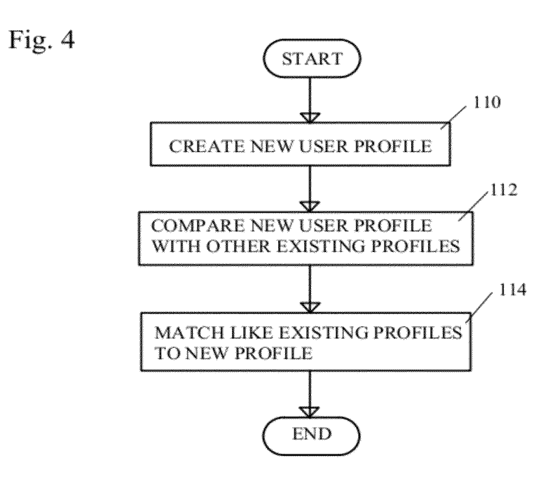

FIG. 4 shows a flowchart of a method of creating a user profile and matching the profile to other profiles in a social network according to an illustrative embodiment. A user creates a new user profile for a social network (step 110). The user can create the new user profile by accessing social network program 14 shown in Figure via a computer. The computer can be, for example, a DVR, such as DVR 8 as shown in FIG. 1, data processing system 20 as shown in FIG. 2, or DVR 18 as shown in FIG. 3, or a client such as client 7 of FIG. 1. When creating the new user profile, the user provides input on what would be considered as inappropriate content within a program through a series of questions regarding but not limited to, personal preferences, children's ages, and appropriate material for the children to view. A computer, such as the DVR, compares the new user profile created in step 110 to other existing profiles in a computer-readable storage device, such as storage device 5 of FIG. 1 (step 112). The computer matches like other existing profiles to the new user profile created (step 114).

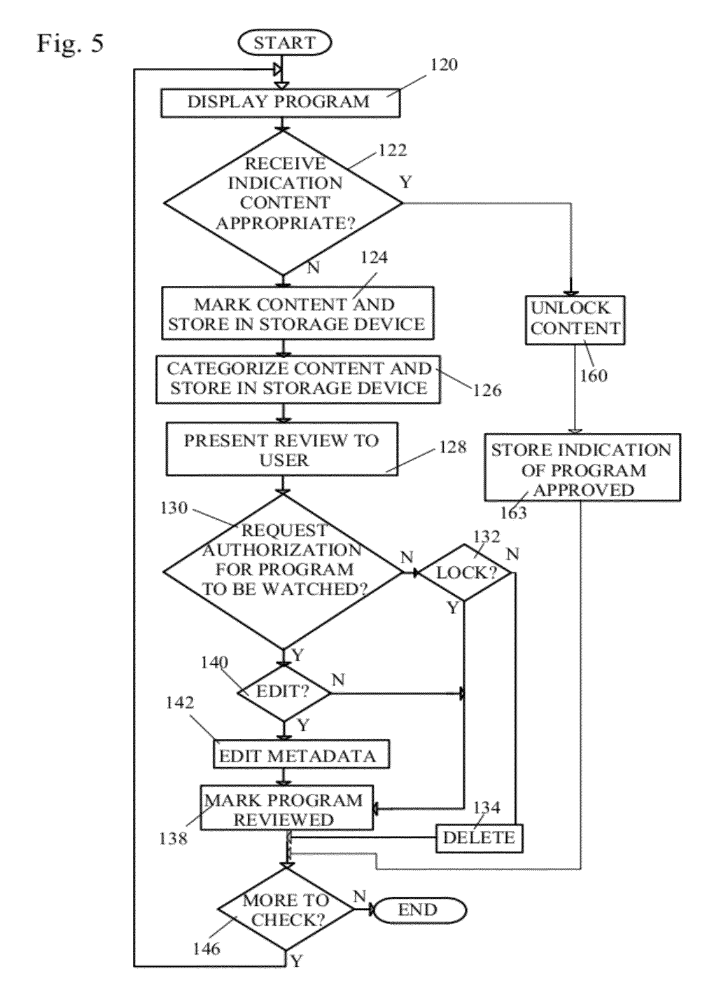

FIG. 5 shows a flowchart of a method of reviewing broadcasts for content within a social network, according to an illustrative embodiment. The method of FIG. 4 may take place immediately before the start of the method shown in FIG. 5 or at some other time prior to the method of FIG. 5. It will be understood that, in one exemplary embodiment, each block or combination of blocks shown in FIG. 5 can be implemented by program instructions of review program 38 of FIG. 2, which computer program instructions can be stored on computer readable storage devices 40 of FIG. 2 and can be executed by processor unit 24 of FIG. 2.

A DVR, such as DVR 8 as shown in FIG. 1, data processing system 20 as shown in FIG. 2 or DVR 18 as shown in FIG. 3, directs a display to display a program (step 120). The program may be, but is not limited to, a live broadcast or a recording of a program chosen by a user. If the DVR receives an indication from the user that there is content within the program that is appropriate for others to view (step 122), the DVR unlocks the content (step 160) and the DVR stores an indication that the program is approved on a computer-readable storage device, such as storage device 5, accessible to a social network program such as social network program 14 of FIG. 1 (step 163). The computer readable storage device accessible to the social network program can also be accessible to the DVR, e.g., via network 2 as shown in FIG. 1. The others may be children associated with the user. If there are no more program to check (step 146), then the method ends. If there are additional programs to check, return to step 120 of the DVR directing the display device to display a program.

If the DVR receives an indication from the user of content with in the program that is inappropriate for others to view (step 122), the DVR marks the content and stores the content on a computer-readable storage device of the DVR (step 124), e.g. one of the computer-readable storage devices 36 of data processing system 20 or computer-readable storage device 54 of DVR 18 as shown in FIG. 3. The DVR also categorizes the content and stores a review of the content on the computer-readable storage device accessible to the social network program (step 126). The DVR can categorize the content based on information received from the user. The user can provide this information to the DVR by, for example, answering questions about the content and/or entering text about the content, e.g. through a device connected to input/output unit 32 of FIG. 2.

Additionally, in the case of visual content, the user may define objectionable matter in a viewable region of the content. The user may use a pointing device to select the viewable region on a display e.g. display device 13 of FIG. 1 or display 34 of FIG. 2, for the specific frame set or time range, for example defining the viewable region as a rectangular region of the screen (X1, Y1-X2, Y2). The DVR may incorporate the definition of the viewable region into the metadata stored on the computer-readable storage device accessible to the social network program. The DVR may use the metadata associated with the definition of the viewable region and the specific frame set or time range during playback to black out the viewable region for the specific frame set or time range. For example, the DVR may use the definition of the viewable region to black out an inappropriate gesture. The DVR may also use a simple algorithm to adjust any differences in aspect ratios between user's displays.

In the case of audio content, a user may define an audio channel for playing the part of the content subject to the user's comments e.g. through a device connected to input/output unit 32 of FIG. 2. For example, the audio channel can be the left front channel of a 7.1 stereo program. Defining an audio channel for playing the part of the content subject to the user's comments is particularly advantageous in that, during the DVR's playback of part of the content, the DVR does not block other audio channels and less of the content of the program would be missed.

The marking of the content at step 124 and the categorizing of the content at step 126 are preferably implemented using time shifting capabilities of the DVR. Time shifting is the recording of a program to a computer-readable storage device so that the program may be viewed or listened to at a time more convenient to the user. Through time shifting, which may be implemented through a device connected to input/output unit 32 of FIG. 2, the DVR can pause a live broadcast, allowing the user to mark and categorize the content and then resume viewing. Depending on the implementation, the user may set a “begin” mark and an “end” mark. In response to the “end” mark being set, the DVR may carry out the categorization process, or alternatively, the DVR may delay the categorization process until the end of the broadcast or an even later time convenient to the user. In another embodiment, the user can mark any number of segments of the broadcast or mark the whole broadcast and categorize the broadcast as a whole.

The review of the content stored on the computer-readable storage device accessible to the social network program is preferably metadata associated with the content, rather than the content itself. The metadata could be, for example, an indication of a frame set of the content within the program e.g. frames 1000-2000 of the program, comments entered by the user's age-specific information for viewing, or other data related to the content. The metadata stored on the computer-readable storage device accessible to the social network program may be represented using xml or other data formats.

The DVR presents the review to the user to check for accuracy (step 128). The DVR requests authorization from the user for the program to be watched (step 130). If the DVR receives authorization from the user for the program to be watched by others (step 130), then the DVR requests that the user specify whether any portions of the program will be edited (step 140). If the user indicates that the program will not be edited, then the DVR marks the program as having been reviewed (step 138). If there are no more programs to check (step 146), then the method ends. If there are additional programs to check, return to step 120 of the DVR directing the display device to display a program.

If the DVR receives authorization from the user to disallow others from watching the program (step 130), and if the DVR receives authorization from the user to lock the program from being watched (step 132), then the program is marked as having been reviewed (step 138). If there are no more programs to check (step 146), then the method ends. If there are additional programs to check, return to step 120 of the DVR directing the display device to display a program.

If the DVR receives authorization from the user to disallow others from watching the program (step 130), and the DVR does not receive authorization to lock the program (step 132), then the DVR deletes the program from the computer-readable storage device of the DVR (step 134). If there are no more programs to check (step 146), then the method ends. If there are additional programs to check, return to step 120 of the DVR directing the display device to display a program.

If in response to the DVR requesting that the user specify whether any portions of the program will be edited (step 140), the user indicates that the program will be edited, the user edits the program using the DVR. Editing the program may include, but is not limited to, muting marked content of the program, deleting marked content of the program, distorting marked content of the program that is viewable, or some other editing technique available through the DVR. For example, for frame set 1000-2000 the user may enter “contains inappropriate language” and time range 00:43:27-00:44:56 “contains mature subject matter”. In another embodiment, the user may enter recommendations for the frame set and/or time range that has inappropriate content and specifically that how the DVR is to edit the inappropriate content (step 242). For example, referring to specifics of the example above, for frame set 1000-2000, mute, and for time range 00:43:27-00:44:56, delete or distort the image. The user may also specify their comments for a specific part of the content.

After the program has been edited, the DVR marks the program as having been reviewed (step 138). If there are no more programs to check (step 146), then the method ends. If there are additional programs to check, return to step 120 of the DVR directing the display device to display a program.

If the DVR receives an indication that there is content within the program that is appropriate for others to view (step 122), the DVR unlocks any locked content of the program (step 160) and the DVR stores an indication that the program has been approved on the computer-readable storage device accessible to the social network program (step 163). If there are no more programs to check (step 146), then the method ends. If there are additional programs to check, return to step 120 of the DVR directing the display device to display a program.

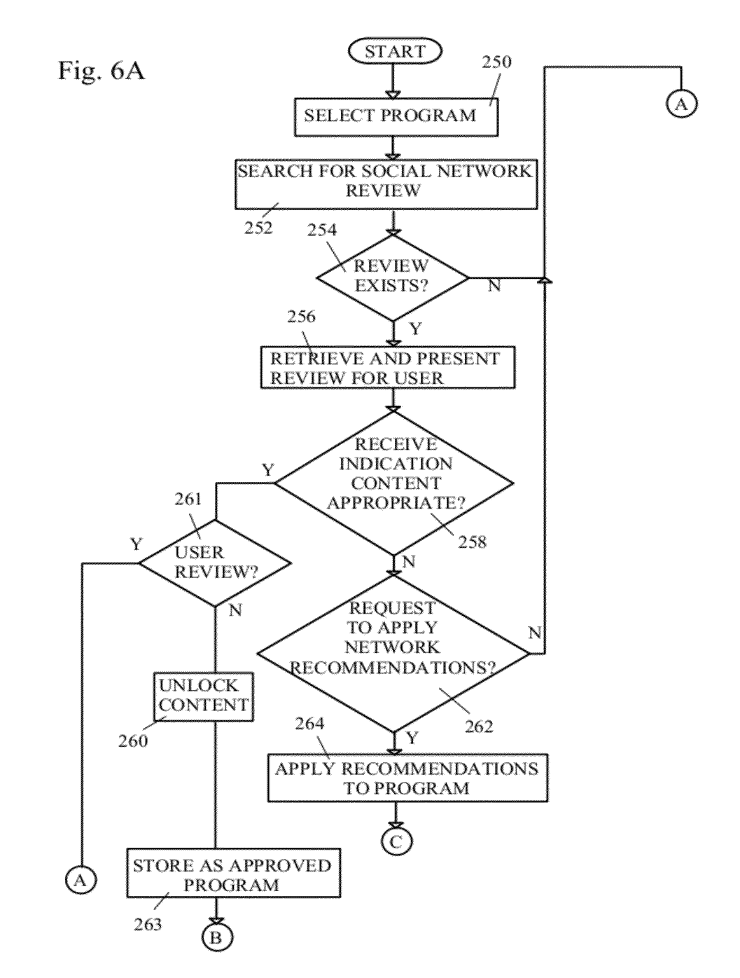

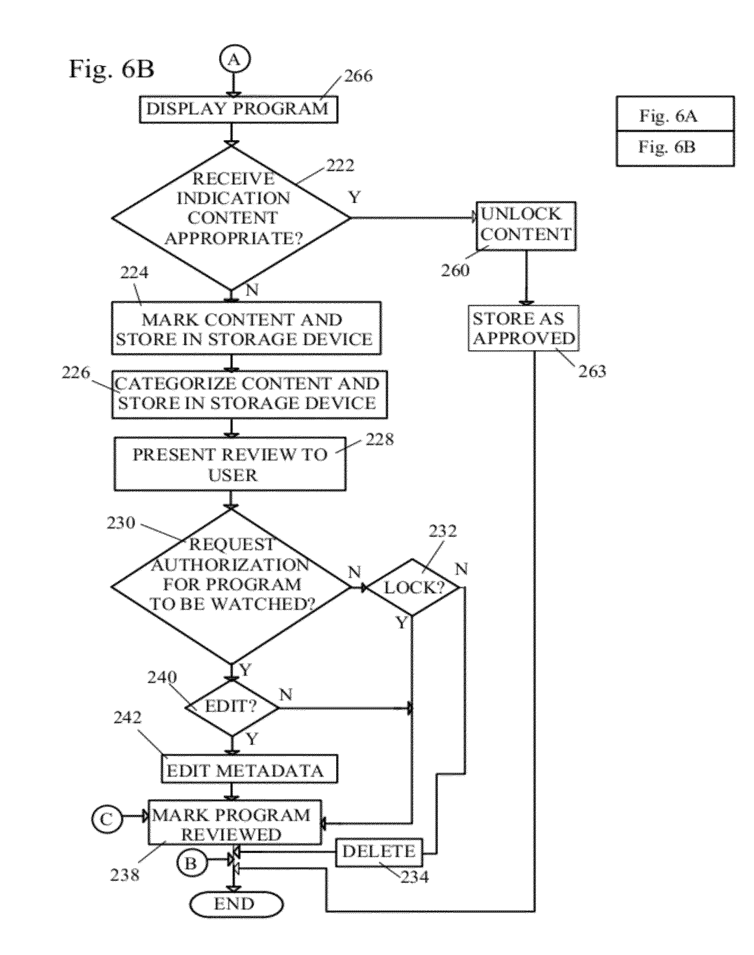

FIGS. 6A and 6B show the steps of reviewing the social network recommendations for program content review according to an illustrative embodiment. The steps of FIG. 4 may take place immediately before the start of the steps shown in FIGS. 6A and 6B or at some other time prior to the steps of FIGS. 6A and 6B. It will be understood that, in one exemplary embodiment, each block or combination of blocks shown in FIG. 6 can be implemented by program instructions of review program 38 of FIG. 2, which computer program instructions can be stored on computer readable storage devices 40 of FIG. 2 and can be executed by processor unit 24 of FIG. 2.

A DVR, such as DVR 8 as shown in FIG. 1, data processing system 20 as shown in FIG. 2, or DVR 18 as shown in FIG. 3, receives, from a user of a social network program 14 of FIG. 1, a selection of a recorded program (step 250). The DVR searches for a social network review of the selected recorded program from a computer-readable storage device, such as storage device 5 of FIG. 1, accessible to the social network program, such as social network program 14 of FIG. 1 (step 252). The computer readable storage device accessible to the social network program can also be accessible to the DVR, e.g., via network 2 as shown in FIG. 1. If a social network review of the selected recorded program exists (step 254), then the DVR retrieves the social network review and presents the social network review to the user (step 256). The DVR can present the social network review to the user on a display. The display can be, e.g. display device 13 of FIG. 1 or display 34 of FIG. 2.

In one embodiment, the social network review can be a merged review of the selected recorded program. For example, at step 256, the DVR can merge reviews of the selected recorded program stored on the computer-readable storage device accessible to the social network program into the merged review. The reviews of the selected recorded program can be, for example, reviews of one or more parents who have children 11-13 years old, are conservative, and have zero tolerance for mature subject matter or foul and offensive language, and the merged review can present a common view of the parents. In another embodiment, at step 250, the DVR can receive, from a user, a selection of one or more members of the social network, and at block 256, the DVR can present the selected members' merged review of the selected recorded program to the user.

If the DVR receives an indication that the content is appropriate for viewing by others (step 258). The others can be, for example, children associated with the user. If the indication is that the selected recorded program has content that is appropriate for viewing by others, and the user is not going to review the recorded program itself on the display device (step 261), then the DVR unlocks the content of the selected recorded program (step 260), the DVR stores an indication that the program has been approved on the computer-readable storage device accessible to the social network program (step 263), and the method ends.

If the indication is that the selected recorded program has content that is inappropriate for viewing by others, and the DVR receives a request to apply network recommendations regarding inappropriate content (step 262), the DVR applies recommendations to the selected recorded program (step 264), marks the selected program as reviewed (step 238), and the method ends. The network recommendations may be, but are not limited to, comments entered by a user in a review with information specific to age or other content related to the program, categorization of the selected program, marking of the selected program including definition of objectionable matter in a viewable region of the content of the selected program and definition of objectionable matter in audio content of the selected program, or any editing of any portion of the selected program.

If the indication is that the selected recorded program has content that is inappropriate for viewing by others, and the DVR receives a request not to apply network recommendations regarding inappropriate content (step 262), then the DVR directs the display device to display the selected recorded program (step 266). In an alternate embodiment, the DVR displays a brief synopsis or grouping of segments of the content of the selected recorded program that is inappropriate for viewing by others rather than displaying the entire selected recorded program.

If the DVR receives an indication from the user that there is content within the program that is appropriate for others to view (step 222), the DVR unlocks the content (step 260), and the DVR stores an indication that the program is approved on a computer-readable storage device, such as storage device 5 of FIG. 1, accessible to a social network program such as social network program 14 of FIG. 1 (step 263).

If the DVR receives an indication from the user of content with in the program that is inappropriate for others to view (step 222), the DVR marks the content and stores the content on a computer-readable storage device of the DVR, e.g. one of the computer-readable storage devices 36 of data processing system 20 or computer readable storage device 54 of DVR 18 (step 224). The DVR also categorizes the content and stores a review of the content on the computer-readable storage device accessible to the social network program (step 226). The DVR can categorize the content based on information received from the user. The user can provide this information to the DVR by, for example, answering questions about the content and/or entering text about the content e.g. through a device connected to input/output unit 32 of FIG. 2.

Additionally, in the case of visual content, the user may define objectionable matter in a viewable region of the content. The user may use a pointing device to select the viewable region on a display, e.g. display device 13 of FIG. 1 or display 34 of FIG. 2, for the specific frame set or time range, for example defining the viewable region as a rectangular region of the screen (X1, Y1-X2, Y2). The DVR may incorporate the definition of the viewable region into the metadata stored on the computer-readable storage device accessible to the social network program. The DVR may use the metadata associated with the definition of the viewable region and the specific frame set or time range during playback to black out the viewable region for the specific frame set or time range. For example, the DVR may use the definition of the viewable region to black out an inappropriate gesture. The DVR may also use a simple algorithm to adjust any differences in aspect ratios between user's displays.

In the case of audio content, a user may define an audio channel for playing the part of the content subject to the user's comments e.g. through a device connected to input/output unit 32 of FIG. 2. For example, the audio channel can be the left front channel of a 7.1 stereo program. Defining an audio channel for playing the part of the content subject to the user's comments is particularly advantageous in that, during the DVR's playback of part of the content, the DVR does not block other audio channels and less of the content of the program would be missed.

The marking of the content at step 224 and the categorizing of the content at step 226 are preferably implemented using time shifting capabilities of the DVR. Time shifting is the recording of a program to a computer-readable storage device so that the program may be viewed or listened to at a time more convenient to the user. Through time shifting, which may be implemented through a device connected to input/output unit 32 of FIG. 2, the DVR can pause a live broadcast, allowing the user to mark and categorize the content and then resume viewing. Depending on the implementation, the user may set a “begin” mark and an “end” mark. In response to the “end” mark being set, the DVR may carry out the categorization process, or alternatively, the DVR may delay the categorization process until the end of the broadcast or an even later time convenient to the user. In another embodiment, the user can mark any number of segments of the broadcast or mark the whole broadcast and categorize the broadcast as a whole.

The review of the content stored on the computer-readable storage device accessible to the social network program is preferably metadata associated with the content, rather than the content itself. The metadata could be, for example, an indication of a frame set of the content within the program (e.g. frames 1000-2000 of the program, comments entered by the user's age-specific information for viewing, or other data related to the content. The metadata stored on the computer-readable storage device accessible to the social network program may be represented using xml or other data formats.

The DVR presents the review to the user to check for accuracy (step 228). The DVR requests authorization from the user for the program to be watched by others (step 230). If the DVR receives authorization from the user for a program to be watched by others (step 230), then the DVR requests that the user specify whether any portions of the program will be edited (step 240). If the user indicates that the program will not be edited, then the DVR marks the program as having been reviewed (step 238). If there are no more programs to check (step 246), then the method ends. If there are additional programs to check, return to step 250 of the DVR directing the display device to display a program.

If the DVR receives authorization from the user to disallow others from watching the program (step 230), and if the DVR receives authorization from the user to lock the program from being watched (step 232), then the program is marked as having been reviewed (step 238) and the method ends.

If the DVR receives authorization from the user to disallow another user to watch the program (step 230), and the DVR does not receive authorization to lock the program (step 232), then the DVR deletes the program from the computer-readable storage device of the DVR (step 234) and the method ends.

If in response to the DVR requesting that the user specify whether any portions of the program will be edited (step 240), the user indicates that the program will be edited, the user edits the program using the DVR. After the program has been edited, then the DVR marks the program as having been reviewed (step 238) and the method ends. Editing the program may include, but is not limited to, muting marked content of the program, deleting marked content of the program, distorting marked content of the program that is viewable, or some other editing technique available through the DVR. For example, for frame set 1000-2000 the user may enter “contains inappropriate language” and time range 00:43:27-00:44:56 “contains mature subject matter”. In another embodiment, the user may enter recommendations for the frame set and/or time range that has inappropriate content and specifically that how the DVR is to edit the inappropriate content (step 242). For example, referring to specifics of the example above, for frame set 1000-2000, mute, and for time range 00:43:27-00:44:56, delete or distort the image. The user may also specify their comments for a specific part of the content.

If the DVR receives an indication that there is content within the program that is appropriate for others to view (step 222), the DVR unlocks any locked content of the program (step 260) and the DVR stores an indication that the program has been approved on the computer-readable storage device accessible to the social network program (step 263) and the method ends.

If the user already reviewed a particular broadcast or recording of a program, the marking and categorizations of that particular program are preferably carried over to any repeat showings of the broadcasting of the program.

In the above embodiments, it is understood that the actual live broadcast and the recorded program digital data may vary from one broadcasting entity to another. For example, a specific episode of Show A on Cable Company 1 may have a commercial starting at time frame 00:05:25:00 and the same episode of show A on Satellite Company 2 may have a commercial starting at time frame 00:06:24:00. To resolve these differences, the metadata may be adjusted prior to and/or after it is stored on the computer-readable storage device accessible to the social network program. By the DVR detecting when commercials start and stop, the DVR may develop a novel mapping to translate time ranges and/or frame sets that include program content and exclude commercials. So, while a 30 minute broadcast of show A may have 2,500,000 frames, only 1,980,000 of the frames may contain content of show A, and the remaining 520,000 frames may contain content of commercials.

Alternatively, if the DVR searches for the social network review information from the recorded program from the computer-readable storage device accessible to the social network (step 252) and a review for the selected program does not exist, then the DVR directs a display of the recorded program (step 250) and steps 222, 224, 226, 228, 230, 232, 240, 242, 238, 234, 246, 260, and 263 may take place as described above.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for sharing reviews of programs for inappropriate content, the method comprising the steps of:
a computer searching for a social network review and recommendation for a selected program from a computer-readable tangible storage device accessible to a social network program, the social network program being accessible to users of the social network and a computer-readable tangible storage device of the computer;
if the social network review is not present, the computer creating the social network review by:
the computer directed to display device to display the selected program to a user;
the computer, in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device accessible to the social network program; and
the computer, in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device accessible to the social network program, the social network program accessible to the computer.

2. The method of claim 1, wherein if the social network review is present, the computer retrieving and presenting the social network review to the user and the computer, in response to receiving an indication of inappropriate content from the user and a request to apply social network recommendations for the inappropriate content from the social network review to the selected program from the user, applying the social network recommendations to the selected program.

3. The method of claim 1, wherein if the social network review is present, the computer retrieving and presenting the social network review to the user and the computer in response to an indication of appropriate content from the user, unlocking content within the selected program and the computer storing an indication that the selected program is approved on the computer-readable tangible storage device of the social network program, the social network program accessible to the social network and the computer-readable tangible storage device of the computer.

4. The method of claim 1, wherein if the social network review is present, the computer retrieving and presenting the social network review to the user and the computer, in response to the indication of inappropriate content from the user, and a denied request to apply social network recommendations from the user:
the computer directing the display device to display the selected program to the user;
the computer, in response to receiving the indication of inappropriate content from the user, marking the inappropriate content within the selected program, categorizing the inappropriate content within the selected program, and storing the marked, categorized inappropriate content of the selected program as the social network review to the computer-readable tangible storage device accessible to the social network program; and
the computer, in response to receiving from the user the request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device accessible to the social network program, the social network program accessible to the computer.

5. The method of claim 1, wherein the computer in response to the request for authorization for the selected program to be watched is denied by the user and content of the selected program unlocked by the user, deleting the selected program from the computer-readable tangible storage device of the computer.

6. The method of claim 1, wherein if the request for authorization for the selected program to be watched is denied and content of the selected program to be locked is received from the user, the computer locking the content of the selected program from viewing by other users from the computer-readable tangible storage device of the computer.

7. The method of claim 1, further comprising:
the computer creating a new user profile for the social network with user preferences;
the computer comparing the new user profile with existing user profiles; and
the computer matching like existing user preferences regarding inappropriate content of the new user profile to existing user preferences regarding inappropriate content of existing user profiles.

8. A computer program product comprising one or more computer-readable, tangible storage devices and computer-readable program instructions which are stored on the one or more storage devices and when executed by one or more processors, perform the method of claim 1.

9. A computer system comprising one or more processors, one or more computer-readable memories, one or more computer-readable, tangible storage devices and program instructions which are stored on the one or more storage devices for execution by the one or more processors via the one or more memories and when executed by the one or more processors perform all the method of claim 1.

10. The method of claim 1, wherein the computer is video recorder.

11. A computer system for sharing reviews of programs for inappropriate content with a social network, the computer system comprising:
one or more processors, one or more computer-readable memories and one or more computer-readable, tangible storage devices of a social network program, the social network program being accessible to users of the social network and a computer-readable tangible storage device of a computer;
program instructions, stored on at least one of the one or more storage devices for execution by at least one of the one or more processors via at least one of the one or more memories, to search for a social network review for a selected program from the computer-readable tangible storage device of a social network program;
program instructions, stored on at least one of the one or more storage devices for execution by at least one of the one or more processors via at least one of the one or more memories, to if the social network review is not present, the computer creating the social network review by:
directing a display device to display the selected program to a user;
in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device of a social network program; and
in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device of a social network program, the social network program being accessible to the computer.

12. The computer system of claim 11, wherein the program instructions to if the social network review is present, retrieving and presenting the social network review to the user and if an indication of inappropriate content is received from the user, and a request to apply social network recommendations for the inappropriate content from the social network review is received from the user, applying the social network recommendations to the selected program.

13. The computer system of claim 11, wherein the program instructions to if the social network review is present, retrieving and presenting the social network review to the user and in response to an indication of appropriate content, unlocking content within the selected program and storing the selected program as approved on the computer-readable tangible storage device of a social network program and the computer-readable tangible storage device of the computer.

14. The computer system of claim 11, wherein the program instructions to if the social network review is present, the computer retrieving and presenting the social network review to the user and the computer, in response to the indication of inappropriate content from the user, and a denied request to apply social network recommendations from the user:
the computer directing the display device to display the selected program to the user;
the computer, in response to receiving the indication of inappropriate content from the user, marking the inappropriate content within the selected program, categorizing the inappropriate content within the selected program, and storing the marked, categorized inappropriate content of the selected program as the social network review to the computer-readable tangible storage device accessible to the social network program; and
the computer, in response to receiving from the user the request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device accessible to the social network program, the social network program accessible to the computer.

15. The computer system of claim 11, the program instructions to in response to the request for authorization for the selected program to be watched is denied by the user and content of the selected program unlocked by the user, deleting the selected program from the computer-readable tangible storage device of the computer.

16. The computer system of claim 11, wherein the program instructions to if the request for authorization for the selected program to be watched is denied and content of the selected program to be locked is received from the user, locking the content of the selected program from viewing by other users on the computer.

17. The computer system of claim 11, further comprising program instructions, stored on at least one of the one or more storage devices for execution by at least one of the one or more processors via at least one of the one or more memories, to:
create a new user profile for the social network with user preferences;
compare the new user profile with existing user profiles; and
match like existing user preferences regarding inappropriate content of the new user profile to existing user preferences regarding inappropriate content of existing user profiles.

18. The computer system of claim 11, wherein the computer is a video recorder.

19. A computer program product for reviews of programs for inappropriate content, the computer program product comprising:
one or more computer-readable, tangible storage devices of a social network program, the social network program being accessible to users of the social network and a computer-readable tangible storage device of a computer;
program instructions, stored on at least one of the one or more storage devices, to search for a social network review for a selected program from the computer-readable tangible storage device of a social network program;
program instructions, stored on at least one of the one or more storage devices, to if the social network review is not present, the computer creating the social network review by:
directing a display device to display the selected program to a user;
in response to receiving an indication of inappropriate content from the user, marking the inappropriate content within the selected program, categorizing the inappropriate content within the selected program, and storing the marked, categorized inappropriate content of the selected program as the social network review to the computer-readable tangible storage device of a social network program; and
in response to receiving from the user a request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device of a social network program, the social network program being accessible to the computer.

20. The computer program product of claim 19, wherein the program instructions to if the social network review is present, retrieving and presenting the social network review to the user and if an indication of inappropriate content is received from the user, and a request to apply social network recommendations for the inappropriate content from the social network review is received from the user, applying the social network recommendations to the selected program.

21. The computer program product of claim 19, wherein the program instructions to if the social network review is present, retrieving and presenting the social network review to the user and in response to an indication of appropriate content, unlocking content within the selected program and storing the selected program as approved on the computer-readable tangible storage device of a social network program and the computer-readable tangible storage device of the computer.

22. The computer program product of claim 19, wherein the program instructions to if the social network review is present, the computer retrieving and presenting the social network review to the user and the computer, in response to the indication of inappropriate content from the user, and a denied request to apply social network recommendations from the user:
the computer directing the display device to display the selected program to the user;
the computer, in response to receiving the indication of inappropriate content from the user, marking the inappropriate content within the selected program, categorizing the inappropriate content within the selected program, and storing the marked, categorized inappropriate content of the selected program as the social network review to the computer-readable tangible storage device accessible to the social network program; and
the computer, in response to receiving from the user the request of authorization for the selected program to be watched and edited, editing metadata of the selected program to indicate deleting segments of the selected program, muting a marked segment of the selected program, or distorting an image in segment of the selected program and storing the edited metadata of the selected program on the computer-readable tangible storage device accessible to the social network program, the social network program accessible to the computer.

23. The computer program product of claim 19, the program instructions to in response to the request for authorization for the selected program to be watched is denied by the user and content of the selected program unlocked by the user, deleting the selected program from the computer-readable tangible storage device of the computer.

24. The computer program product of claim 19, wherein the program instructions to if the request for authorization for the selected program to be watched is denied and content of the selected program to be locked is received from the user, locking the content of the selected program from viewing by other users on the computer.

25. The computer program product of claim 19, further comprising program instructions, stored on at least one of the one or more storage devices for execution by at least one of the one or more processors via at least one of the one or more memories, to:
create a new user profile for the social network with user preferences;
compare the new user profile with existing user profiles; and
match like existing user preferences regarding inappropriate content of the new user profile to existing user preferences regarding inappropriate content of existing user profiles.

26. The computer program product of claim 19, wherein the computer is a video recorder.
